(19) United States
(12) Patent Application Publication
(10) Pub. No.: US 2002/0148167 A1
(43) Pub. Date: Oct. 17, 2002

(54) Inner actuation means for doors of automobiles

(75) Inventor: Gunther Muller, Wurzburg (DE)

Correspondence Address: LOWE HAUPTMAN GOPSTEIN GILMAN & BERNER, LLP, Suite 310, 1700 Diagonal Road, Alexandria, VA, 22314, US

(73) Assignee: ITW Automotive Products GmbH & Co. KG.

(21) Appl. No.: 10/118,890

(22) Filed: Apr. 10, 2002

(30) Foreign Application Priority Data
Apr. 14, 2001 (DE) 101 18 658.4

(51) Int. Cl. B60J 5/04

(52) U.S. Cl. 49/502

(57) ABSTRACT

Inner actuation means for doors of automobiles comprising a lever-like handle adapted to be pivoted about an axis within a housing which is attached to the door, a linkage or an actuating cable which is led to a door lock and engages the handle, spring means which bias the handle into a rest position, a damper which is connected to a portion of the handle such that the movement of the handle into the rest position is damped, whereby a linear damper (30) is provided which is linked to the door with one end and to a portion of the handle with the other hand.

This invention relates to an inner actuation means for doors of automobiles according to claim 1.

DE 199 07 883 has made known an inner actuation means for doors wherein a lever-like handle is supported so as to be pivotable about an axis within a housing which, in turn, is attached to the door. A portion of the handle is connected to the door lock via a linkage or actuating cable. A spring biases the handle into a rest position. A portion of the handle is toothed and engages with a pinion which is seated on the axle of a silicone rotary damper. Such an assembly efficiently meets the purpose of damping the pull-back motion of the door inside lever. The assembly described has a fixed geometrical association of its parts or components. Frequently, there is not sufficient space to integrate the known inner actuation means for doors in the automobile door.

It is the object of the invention to provide a low-noise inner actuation means for doors of automobiles which is small in construction and is adapted to be integrated into any configurations of a door.

The object is achieved by the features of claims 1 and 2.

The inner actuation means for doors according to claim 1 provides a linear damper which is fixedly attached to the door at one end and is hinged to a handle portion at the other end. The linear damper is preferably a so-called air damper which is preferably fitted with a free-moving device. Such air dampers are known as such. They mostly use a sealing member which is very permeable to air in one direction and is hardly permeable to air in the other direction. Air dampers have a number of advantages.

Because of its geometrical set-up, an air damper has an integrated free-moving device which can be employed for the direction of handle actuation. Furthermore, an air damper is easier to manufacture with less expenditure than a so-called silicone damper (rotary damper) having a free-moving device. An air damper is nearly independent on temperature. Its temperature dependence caused by different expansion coefficients of the parts it uses is negligible. A silicone damper the viscosity of which governs the braking torque features a heavy dependence on temperature. If there are below-zero temperatures the handle will be restored distinctly more slowly, which does not allow to close the door quickly.

Finally, a linear damper has the advantage to be disposable at many points adjacent to the inner actuation means for doors, e.g. on the housing of the handle, the sheet of the door, the door trimming, etc. According to an aspect of the invention, the working directions of the linkage or cable, on one hand, and the linear damper, on the other, are approximately parallel. A particularly space-saving solution is obtained, as a result.

It is understood that an air damper can be disposed to react to a pressure or pull. If it is disposed to react to pressure the restoring forces which can be absorbed are higher than those for a reaction to a pull.

According to a particularly advantageous aspect of the invention according to claim 1, the restoring spring is disposed in the housing of the air damper. The spring may be a simple compression spring which is easier to manufacture and mount than are the common leg springs on the axle of the inner actuation means for doors. Since the latter constitutes a potential source of noise the inventive configuration largely suppresses the formation of noise, particularly if a spring is used the wire of which is encased in plastic, in another aspect of the invention.

The inventive solution of claim 2 provides a rotary damper which is fixedly attached to the door remote from the handle and has a pinion, and a portion of the handle has hinged thereto a toothed rack which is guided by a guide means, the guide means holding the toothed rack in engagement with the pinion. This inventive solution also helps obtain a space-saving construction which is adaptable to any spatial conditions. Thus, the silicone damper may be mounted on a location remote from the handle. Since the guide causes the toothed rack to engage the pinion any tolerances of the handle shell, axle bearing, and handle are insignificant. Using a guide also allows the toothed rack to engage the pinion at a low noise.

Embodiments of the inventions will now be explained in more detail with reference to the drawings.

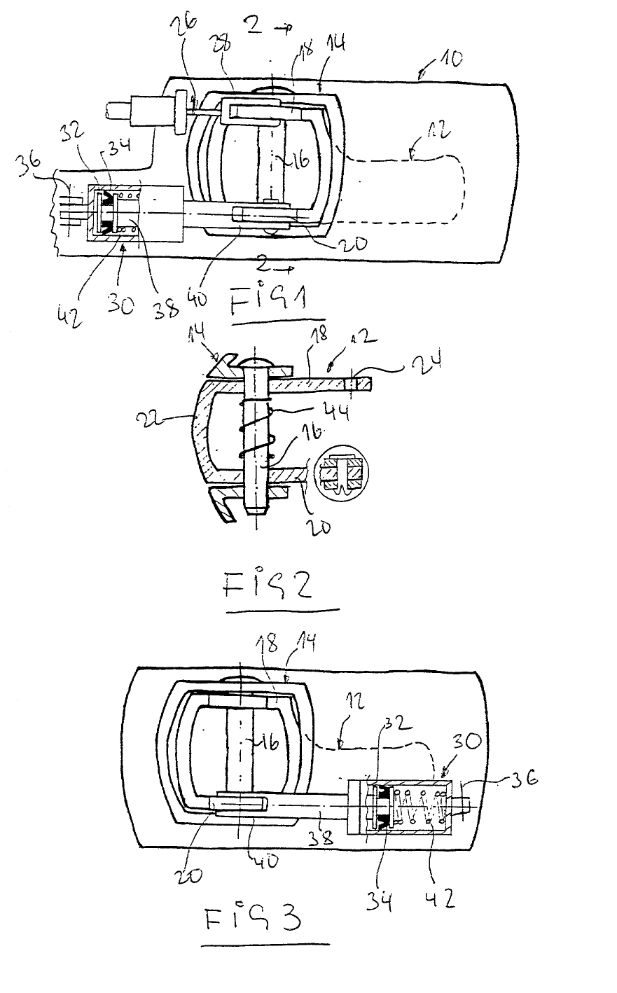

FIG. 1 schematically shows an inner actuation means for doors as seen from outside with a linear damper according to the invention.

FIG. 2 shows a section taken through the assembly of FIG. 1 along lines 2-2.

FIG. 3 shows an assembly similar to that of FIG. 1, but with the linear damper placed at a different point.

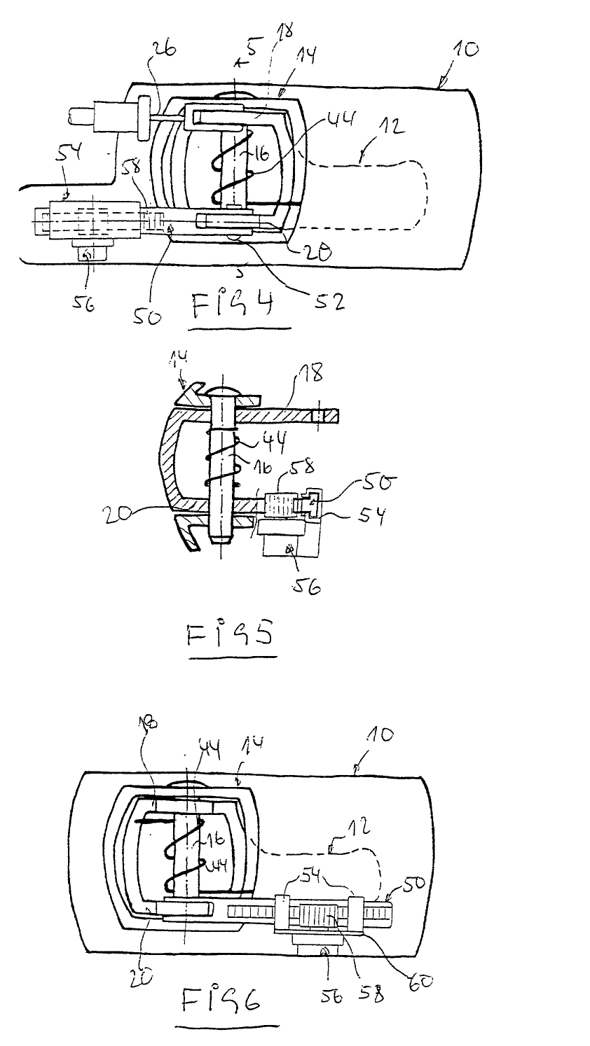

FIG. 4 shows an assembly of an inner actuation means for doors similar to that of FIG. 1, but with a rotary damper.

FIG. 5 shows a section taken through the assembly of FIG. 4 along lines 5-5.

FIG. 6 shows an assembly similar to that of FIG. 4, but with the rotary damper placed at a different point.

The components of the inner actuation means for doors which are shown in the Figures, in structure and arrangement, are the same as those described in DE 199 07 683. Therefore, reference is explicitly made to this document.

Referring to FIG. 1, a shell 10 is outlined which is set into the inner trimming of an automobile door (not shown). An actuation lever is located within the shell 10 and, therefore, is partially shown in phantom lines in FIG. 2. It extends towards the outer surface of the door through the shell 10 into a housing 14 which retains a bearing pin 16. The bearing pin 16, which is vertically disposed in the present case, pivotally supports the actuation lever 12. The actuation lever 12 has two legs 18, 20 which are linked to each other via a bent portion 22.

Legs 18, 20 have apertures through which the bearing pin 16 extends. The leg 18, for example, has hinged thereto a pulling cable of a cable mechanism via a hole 24 as can be seen at 26 in FIG. 1. Connected to the cable is a U-shaped component 28 which is hinged to the leg 18 via a pin link or the like. Thus, actuating the lever 12 results in an actuation of the cable 16 and, hence, an operation of a lock (not shown) of the door.

FIG. 1 further illustrates a linear air damper 30. The air damper 30, which is of a design known as such, has a piston 32 with a ring seal 34 which is configured such as to cause the air damper to let pass more air in one direction and to let pass less air in the other direction, thus effecting a damping action in one direction and causing a free motion in the other. The air damper 30 is hinged to the shell 10 at 36. It is understood that it can also be fixedly hinged to the sheet of the door on the door trimming or another component. Thus, the position of the damper 30 is relatively random. In the case shown, the axle of the damper 30 is approximately parallel to the working direction of the cable 26, which saves particularly much space.

The piston rod 38 is led out of the housing of the damper 30 and is designed in a fork shape at 40 at the end in order to be hinged to leg 20 of lever 12. A restoring spring 42 for the lever 12, e.g. a compression spring, is seated on the piston rod 38 in the housing. This way realizes a low-noise arrangement of the spring, particularly if the spring is made of a plastic-coated wire.

The illustration of FIG. 2 is merely intended to elucidate the structure of the lever 12 and housing 14 with a restoring spring 44, however, being disposed on the bearing pin 16 in contrast to FIG. 1.

FIG. 3 illustrates the same components as does FIG. 1. Therefore, they are given the same reference numbers. The only distinction from FIG. 1 is that the linear damper 30 is disposed on the opposite side. The restoring spring 42 is a tension spring, for example. The embodiment of FIG. 4 also provides nearly the same parts as in the embodiment of FIG. 1. Therefore, the same reference numbers are used again. However, a restoring spring 44 is disposed on the bearing axle 16 like in FIG. 2. It further is apparent from FIG. 4 that a toothed rack 50 is hinged to the leg 20 at 52. The toothed rack extends through a guide 54 which is mounted on a rotatably supported rotary damper 56 that has a pinion 58. Such rotary or silicone dampers are generally known. Actuating the lever 12 moves the toothed rack 50 linearly and pivots it simultaneously. The guide 54 joins this pivoting motion while ensuring that the teeth 58 of the toothed rack 50 is in permanent engagement with the pinion 58. The toothed rack 50 and the pinion 58 are preferably made of plastic to bring about a low-noise interengagement.

The distinction of the embodiment of FIG. 6 from that of FIG. 4 is that the toothed rack 50 is disposed on the side opposed to that of FIG. 4. However, the remaining components are the same except for the guide 54 which, in the embodiment of FIG. 6, is composed of two guide portions which are pivotally or rotatably supported about the rotary damper 56 via a joint structural member 60 in order to join the pivoting motion of the toothed rack 54 when it is actuated.

The rotary damper in the embodiment of FIGS. 4 to 6 may also be fitted with a free-moving device.

1. Inner actuation means for doors of automobiles comprising a lever-like handle adapted to be pivoted about an axis within a housing which is attached to the door, a linkage or an actuating cable which is led to a door lock and engages the handle, spring means which bias the handle into a rest position, a damper which is connected to a portion of the handle such that the movement of the handle into the rest position is damped, characterized in that a linear damper (30) is provided which is linked to the door with one end and to a portion of the handle with the other hand.

2. Inner actuation means for doors of automobiles comprising a lever-like handle adapted to be pivoted about an axis within a housing which is attached to the door, a linkage or an actuating cable which is led to a door lock engaging the handle, spring means which bias the handle into a rest position, a damper which is connected to a portion of the handle such that the movement of the handle into the rest position is damped, characterized in that a rotary damper (56) is provided which is fixedly attached to the door remote from the handle (12), the rotary damper including a pinion (58), a portion (20) of the handle being linked to a tooth rod (50) which is guided by guide means (54), the guide means holding the tooth rod in engagement with pinion (58).

3. The actuation means of claim 1, wherein the effecting direction of a linkage or the cable (26) on the one side and of the linear damper (30) or the tooth rod (50), respectively, on the other side is approximately parallel.

4. The actuation means of claim 1 or 3, wherein the linear damper (30) is linked to the housing, to the sheet of the door or to the lining of the door.

5. The actuation means of claim 1, 3 or 4, wherein the reset spring (52) is located in the housing of the linear damper (30).

6. The actuation means of claim 5, wherein the reset spring (52) is made of wire coated with plastic material.
